(19) United States
(12) Patent Application Publication
(10) Pub. No.: US 2016/0007391 A1
(43) Pub. Date: Jan. 7, 2016

(54) NETWORK ACCESS METHOD, APPARATUS, SERVER AND TERMINAL

(71) Applicant: Alibaba Group Holding Limited, Grand Cayman (KY)

(72) Inventors: Yang Yu, Hangzhou (CN); Hui Dong, Hangzhou (CN)

(73) Assignee: Alibaba Group Holding Limited

(21) Appl. No.: 14/789,436

(22) Filed: Jul. 1, 2015

(30) Foreign Application Priority Data
Jul. 2, 2014 (CN) 201410313274.6

(51) Int. Cl. H04W 76/02; H04W 48/08

(52) U.S. Cl. CPC H04W 76/021; H04W 48/08; H04W 88/02

(57) ABSTRACT

A method, an apparatus, a server and a terminal of accessing a network are disclosed. The method includes: receiving a first base station identifier and a first terminal identifier of a terminal from the terminal, the first base station identifier being a base station identifier of a first Bluetooth base station acquired by the terminal after establishing a connection with the first Bluetooth base station; obtaining a first access point device associated with the first Bluetooth base station based on the first base station identifier; and sending an access instruction to the first access point device to cause the first access point device to allow the terminal to access a wireless network upon verifying that the terminal has been registered based on the first terminal identifier. Using the embodiments of the present disclosure, a terminal can automatically access a wireless network without the need of a terminal user to perform cumbersome input operations manually, thereby improving the speed of accessing a network.

### CROSS REFERENCE TO RELATED PATENT APPLICATION

This application claims foreign priority to Chinese Patent Application No. 201410313274.6 filed on Jul. 2, 2014, entitled “Network Access Method, Apparatus, Server and Terminal”, which is hereby incorporated by reference in its entirety.

### TECHNICAL FIELD

The present disclosure relates to the field of communications technologies, and more particularly, to methods, apparatuses, servers and terminals of accessing a network.

### BACKGROUND

With the development of wireless networks and the enhancement of functionalities of intelligent terminals, a user may access a WIFI (Wireless Fidelity) network using an intelligent terminal of the user when entering some public places provided with access point (AP) devices, so as to realize an Internet access function. When accessing a WIFI network, the intelligent terminal first enables a function of the terminal for setting a network connection, search for nearby WIFI networks using the function, then selects a WIFI network to which the user needs to log in based on a user name of the WIFI network, inputs a password that is associated with the WIFI network, and logs into the WIFI network upon correct input.

As can be seen, the foregoing process of accessing a WIFI network requires a user to manually enable a network connection setting function and input a password of the WIFI network, thus creating cumbersome operations and poor user experience.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure. The present disclosure provides a method, an apparatus, a server and a terminal of accessing a network so as to improve convenience in network access.

According to a first aspect of embodiments of the present disclosure, a network access method is provided. The method may include: receiving a first base station identifier and a first terminal identifier of a terminal from the terminal, the first base station identifier being a base station identifier of a first Bluetooth base station acquired by the terminal after establishing a connection with the first Bluetooth base station; obtaining a first access point device associated with the first Bluetooth base station based on the first base station identifier; and sending an access instruction to the first access point device to cause the first access point device to allow the terminal to access a wireless network upon verifying that the terminal has been registered based on the first terminal identifier.

According to a second aspect of the embodiments of the present disclosure, another network access method is provided. The method may include: acquiring a first base station identifier of a first Bluetooth base station upon establishing a connection with the first Bluetooth base station; sending the first base station identifier and a first terminal identifier of a terminal to a server to cause the server to send an access instruction to a first access point device that is associated with the first Bluetooth base station and that is obtained based on the first base station identifier upon verifying that the terminal has been registered based on the first terminal identifier to cause the first access point device to allow the terminal to access a wireless network; and accessing the wireless network provided by the first access point device.

According to a third aspect of the embodiments of the present disclosure, a network access apparatus is provided. The apparatus may include: a receiving unit to receive a first base station identifier and a first terminal identifier of a terminal from the terminal, the first base station identifier being a base station identifier of a first Bluetooth base station acquired by the terminal after establishing a connection with the first Bluetooth base station; an acquisition unit to obtain a first access point device associated with the first Bluetooth base station based on the first base station identifier that is received by the receiving unit; a verification unit to verify whether the terminal has been registered based on the first terminal identifier received by the receiving unit; and a control unit to send an access instruction to the first access point device to cause the first access point device to allow the terminal to access a wireless network after the verification unit verifies that the terminal has been registered.

According to a fourth aspect of the embodiments of the present disclosure, another network access apparatus is provided. The apparatus may include: an establishing unit to establish a connection with a first Bluetooth base station; an acquisition unit to obtain a first base station identifier of the first Bluetooth base station that is connected by the establishing unit; a sending unit to send the first base station identifier and a first terminal identifier of a terminal to a server to cause the server to deliver an access instruction to a first access point device that is associated with the first Bluetooth base station and that is obtained based on the first base station identifier upon verifying that the terminal has been registered based on the first terminal identifier to cause the first access point device to allow the terminal to access a wireless network; and an access unit to access the wireless network provided by the first access point device.

According to a fifth aspect of the embodiments of the present disclosure, a server is provided. The server may include: processor(s) and memory storing instructions executable by the processor(s), wherein the processor(s) is/are configured to:

receive a first base station identifier and a first terminal identifier of a terminal from the terminal, the first base station identifier being a base station identifier of a first Bluetooth base station acquired by the terminal after establishing a connection with the first Bluetooth base station;

obtain a first access point device associated with the first Bluetooth base station based on the first base station identifier; and

send an access instruction to the first access point device to cause the first access point device to allow the terminal to access a wireless network upon verifying that the terminal has been registered.

According to a sixth aspect of the embodiments of the present disclosure, a terminal is provided. The terminal may include: processor(s) and memory storing instructions executable by the processor(s), wherein the processor(s) is/are configured to:

obtain a first base station identifier of a first Bluetooth base station upon establishing a connection with the first Bluetooth base station;

deliver the first base station identifier and a first terminal identifier of a terminal to a server to cause the server to send an access instruction to a first access point device that is associated with the first Bluetooth base station and that is obtained based on the first base station identifier upon verifying that the terminal has been registered based on the first terminal identifier to cause the first access point device to allow the terminal to access a wireless network; and

access the wireless network provided by the first access point device.

In the embodiments of the present disclosure, by making use of an association between an access point device and a Bluetooth base station, when entering the coverage of a wireless network that is covered by an access point device and has Bluetooth base stations deployed therein, a terminal only needs to report a terminal identifier and a base station identifier of a Bluetooth base station that is found to a server. Upon verifying that the terminal is a registered terminal, the server delivers an instruction that allows the terminal to access the wireless network to an access point device associated with the Bluetooth base station, so that the terminal can automatically access the wireless network without the need to perform cumbersome input operations manually by a terminal user, thereby improving the speed of accessing the network.

It should be understood that the foregoing general description and the following detailed description are merely exemplary and explanatory, and should not be construed as limiting the present disclosure.

### BRIEF DESCRIPTION OF THE DRAWINGS

FIG. 1 is a flowchart of a network access method in accordance with an embodiment of the present disclosure.

FIG. 2 is a flowchart of a network access method in accordance with another embodiment of the present disclosure.

FIG. 3 is a schematic diagram of an example application scenario of the embodiments in the present disclosure.

FIG. 4 is a flowchart of a network access method in accordance with another embodiment of the present disclosure.

FIG. 5A is a block diagram of a network access apparatus in accordance with an embodiment of the present disclosure.

FIG. 5B is a block diagram of a network access apparatus in accordance with an embodiment of the present disclosure.

FIG. 5C is a block diagram of a network access apparatus in accordance with an embodiment of the present disclosure.

FIG. 5D is a block diagram of a network access apparatus in accordance with an embodiment of the present disclosure.

FIG. 6A is a block diagram of a network access apparatus in accordance with another embodiment of the present disclosure.

FIG. 6B is a block diagram of a network access apparatus in accordance with another embodiment of the present disclosure.

FIG. 6C is a block diagram of a network access apparatus in accordance with another embodiment of the present disclosure.

FIG. 6D is a block diagram of a network access apparatus in accordance with another embodiment of the present disclosure.

FIG. 7 is a block diagram of a server in accordance with an embodiment of the present disclosure.

FIG. 8 is a block diagram of a terminal in accordance with an embodiment of the present disclosure.

FIG. 9 is a block diagram of the example apparatus as described in FIGS. 5A-D, 6A-C, 7 and 8 in more detail.

### DETAILED DESCRIPTION

Exemplary embodiments will be described in detail herein, with examples thereof being illustrated in accompanying drawings. When the accompanying drawings are described, the same number in different drawings represents the same or similar element unless indicated otherwise. Implementations described in the following exemplary embodiments do not represent all of the implementations that are consistent with the present disclosure. Instead, they are merely examples of apparatuses and methods that are consistent with some aspects of the present disclosure as recited in the appended claims.

Terms in the present disclosure are used for the purpose of describing specific embodiments only and are not intended to limit the present disclosure. Terms “a”, “an”, and “the” in singular forms as used in the present disclosure and in the appended claims are also intended to cover plural forms, unless specified clearly otherwise in the context. It should also be understood that a term “and/or” used herein indicates and includes any or all possible combinations of one or more associated items that are listed.

It should be understood that, although terms such as “first”, “second”, and “third” are used in the present disclosure to describe various types of information, these pieces of information are not limited to these terms. These terms are merely used to distinguish information of a same type. For example, first information may also be referred to as second information, and similarly, second information may also be referred to as first information without departing from the scope of the present disclosure.

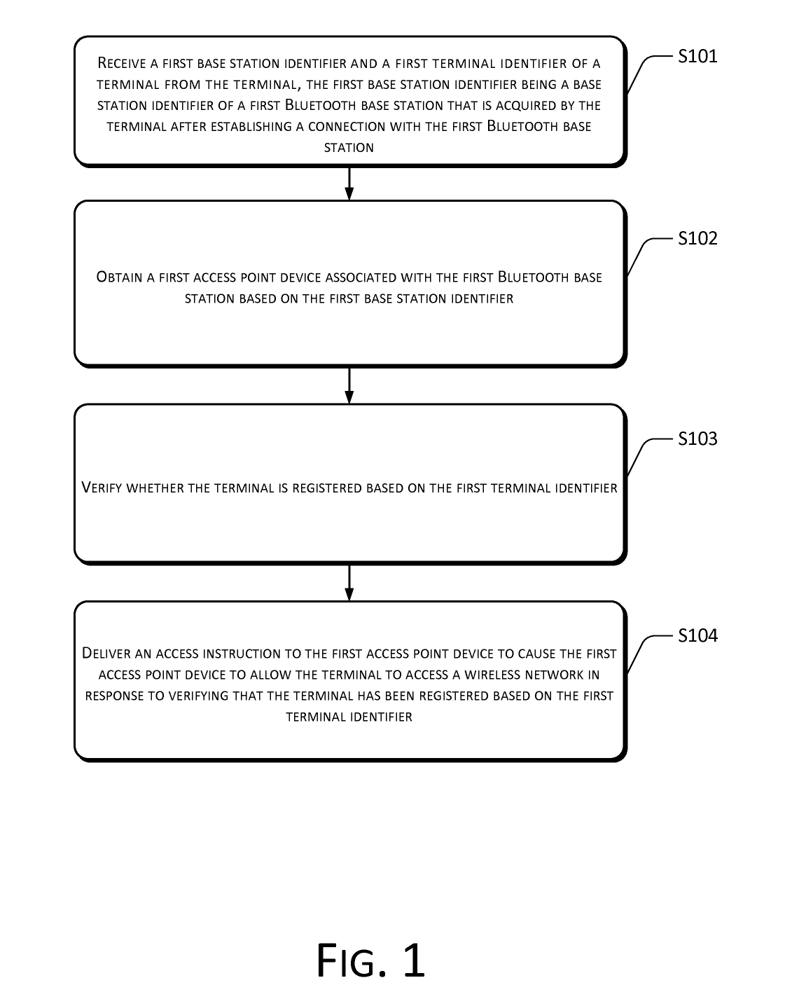

FIG. 1 is a flowchart of a network access method in accordance with an embodiment of the present disclosure. This embodiment is described from a server side.

Block S101 receives a first base station identifier and a first terminal identifier of a terminal from the terminal, the first base station identifier being a base station identifier of a first Bluetooth base station that is acquired by the terminal after establishing a connection with the first Bluetooth base station.

The embodiments of the present disclosure employ a Bluetooth Low Energy (BLE) technology to realize access to a wireless network by a terminal. A plurality of Bluetooth base stations may be disposed within the coverage of a wireless network of an access point device, and signal ranges of the Bluetooth base stations fall within the wireless network coverage of the access point device. An association between the Bluetooth base stations and the access point device is established. Based on the association between the Bluetooth base stations and the access point device, a server may store binding relationships between a device identifier of the access point device and base station identifiers of the Bluetooth base stations that are associated with the access point device in advance. In this embodiment, the access point device may be a wireless AP device, a wireless router (including a wireless network card or a wireless bridge), etc.

Each Bluetooth base station may create a respective signal region, and correspondingly, a Bluetooth module is disposed in the terminal. In response to enabling a Bluetooth function of the Bluetooth module and entering into the signal region of the Bluetooth base station, the terminal may establish a Bluetooth connection with the Bluetooth base station to obtain a base station identifier of the Bluetooth base station. The base station identifier may be a base station media access control (MAC) address of the Bluetooth base station. A first terminal identifier of the terminal may uniquely identify the terminal. The first terminal identifier may include at least one of MAC addresses as follows: a Bluetooth MAC address of the Bluetooth module disposed in the terminal and a wireless network card MAC address of the terminal.

Before accessing the access point device, the terminal may send the first base station identifier and the first terminal identifier of the terminal to the server through a third generation (3G) mobile network.

Block S102 obtains a first access point device associated with the first Bluetooth base station based on the first base station identifier.

In an embodiment, upon receiving the first base station identifier, the server may search the pre-stored binding relationships to obtain a first device identifier corresponding to the first base station identifier, and determine that an access point device corresponding to the first device identifier as a first access point device. The first access point device is an access point device that provides a wireless network to be accessed by the terminal.

Block S103 verifies whether the terminal is registered based on the first terminal identifier.

In an embodiment, terminals may register with the server through a pre-installed application, and provide terminal identifiers of the terminals to the server during registration to facilitate the server to store all terminal identifiers that have been registered. After receiving the first terminal identifier from the terminal, the stored terminal identifiers are searched. If the first terminal identifier is found, the terminal is verified to have undergone registration, that is, a user of the terminal is a trusted user.

Block S104 delivers an access instruction to the first access point device to cause the first access point device to allow the terminal to access a wireless network in response to verifying that the terminal has been registered based on the first terminal identifier.

If the terminal has been registered, the server may deliver an access instruction to the first access point device. The first access point device allows the terminal to automatically access a wireless network according to the access instruction.

As can be seen from the foregoing method embodiment, when entering the coverage of a wireless network that is covered by an access point device and has Bluetooth base stations deployed therein, a terminal only needs to report a terminal identifier and a base station identifier of a Bluetooth base station that is found to a server. Upon verifying that the terminal is a registered terminal, the server delivers an instruction that allows the terminal to access the wireless network to an access point device associated with the Bluetooth base station so that the terminal can automatically access the wireless network without the need of a terminal user to perform cumbersome input operations manually, thereby improving the speed of accessing the network.

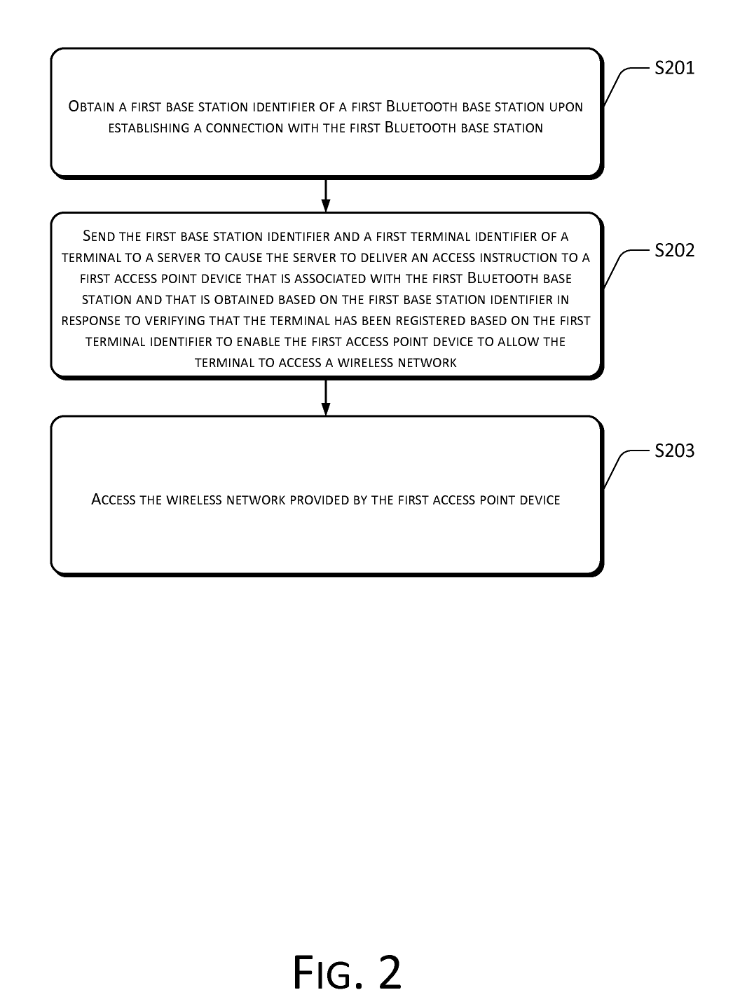

As shown in FIG. 2, FIG. 2 is a flowchart of another embodiment of the network access method in accordance with the present disclosure. This embodiment is described from a terminal side.

Block S201 obtains a first base station identifier of a first Bluetooth base station upon establishing a connection with the first Bluetooth base station.

Block S202 sends the first base station identifier and a first terminal identifier of a terminal to a server to cause the server to deliver an access instruction to a first access point device that is associated with the first Bluetooth base station and that is obtained based on the first base station identifier in response to verifying that the terminal has been registered based on the first terminal identifier to enable the first access point device to allow the terminal to access a wireless network.

Block S203 accesses the wireless network provided by the first access point device.

In an embodiment, the server may pre-store binding relationships. The binding relationships include binding relationships among device identifiers of access point devices, SSIDs of the access point devices, and base station identifiers of respective Bluetooth base stations that are associated with the access point devices. After receiving the first base station identifier sent from the terminal, the server may search the binding relationships to obtain a first SSID of the first access point device corresponding to the first base station identifier, and send the first SSID to the terminal. The terminal establishes a connection with the first access point device based on the first SSID. Furthermore, the terminal establishes a network verification channel with the first access point device. In an embodiment of the present disclosure, the terminal does not need a user to input a user name and a password for network verification. After the first access point device receives an instruction delivered from the server that allows the terminal to access the wireless network, the first access point device determines that the network verification is successful for the terminal which has established the connection, and allows the terminal to access thereto, and further access the Internet through the wireless network provided by the first access point device.

An implementation process of the embodiment shown in FIG. 2 is the same as that of the embodiment shown in FIG. 1, and is not repeatedly described herein. As can be seen from the foregoing method embodiment, when entering the coverage of a wireless network that is covered by an access point device and has Bluetooth base stations deployed therein, a terminal only needs to report a terminal identifier and a base station identifier of a Bluetooth base station that is found to a server. Upon verifying that the terminal is a registered terminal, the server delivers an instruction that allows the terminal to access the wireless network to an access point device associated with the Bluetooth base station so that the terminal can automatically access the wireless network without the need of a terminal user to perform cumbersome input operations manually, thereby improving the speed of accessing the network.

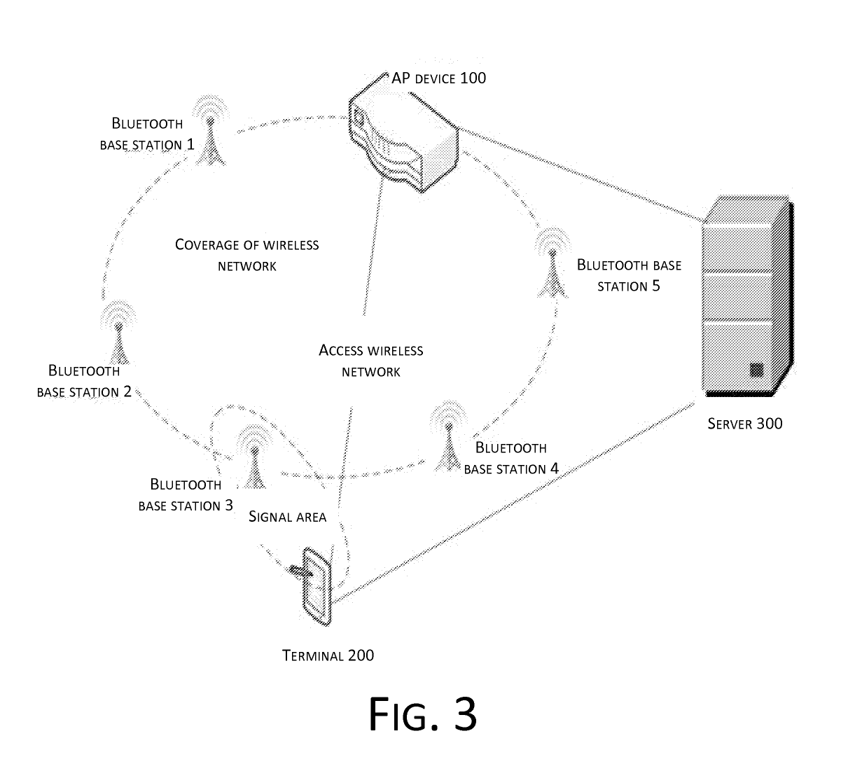

FIG. 3 is a schematic diagram of an example application scenario in accordance with the present disclosure.

FIG. 3 includes an AP device 100, Bluetooth base station 1 through Bluetooth base station 5, a terminal 200 and a server 300.

The AP device 100 may be disposed at any location, for example, a mall, a restaurant, etc., that provides a wireless network to users. The Bluetooth base stations 1-5 are disposed along the border of the coverage of the wireless network of the AP device 100. These Bluetooth base stations form an electronic fence of the AP device 100. In other words, each Bluetooth base station has a respective signal region, and a combination of the signal regions of the Bluetooth base stations can cover the border portion within the coverage of the wireless network. The terminal 200 is configured with a Bluetooth module. Enabling a Bluetooth function of the Bluetooth module allows connection to a Bluetooth base station disposed in the coverage of the wireless network once the terminal 200 enters the coverage of the wireless network. As shown in FIG. 3, in response to entering a signal region of Bluetooth base station 3, the terminal 200 establishes a Bluetooth connection with the Bluetooth base station 3 using the Bluetooth module in the terminal 200. The server 300 communicates with the AP device 100 and the terminal 200 separately. Upon verifying that the terminal 200 has been registered, the server 300 may deliver an access instruction to the AP device 100 that is associated with the Bluetooth base station 3 connected with the terminal 200 to cause the AP device 100 to allow accesses by the terminal 200, thus realizing an automatic access of the wireless network by the terminal 200.

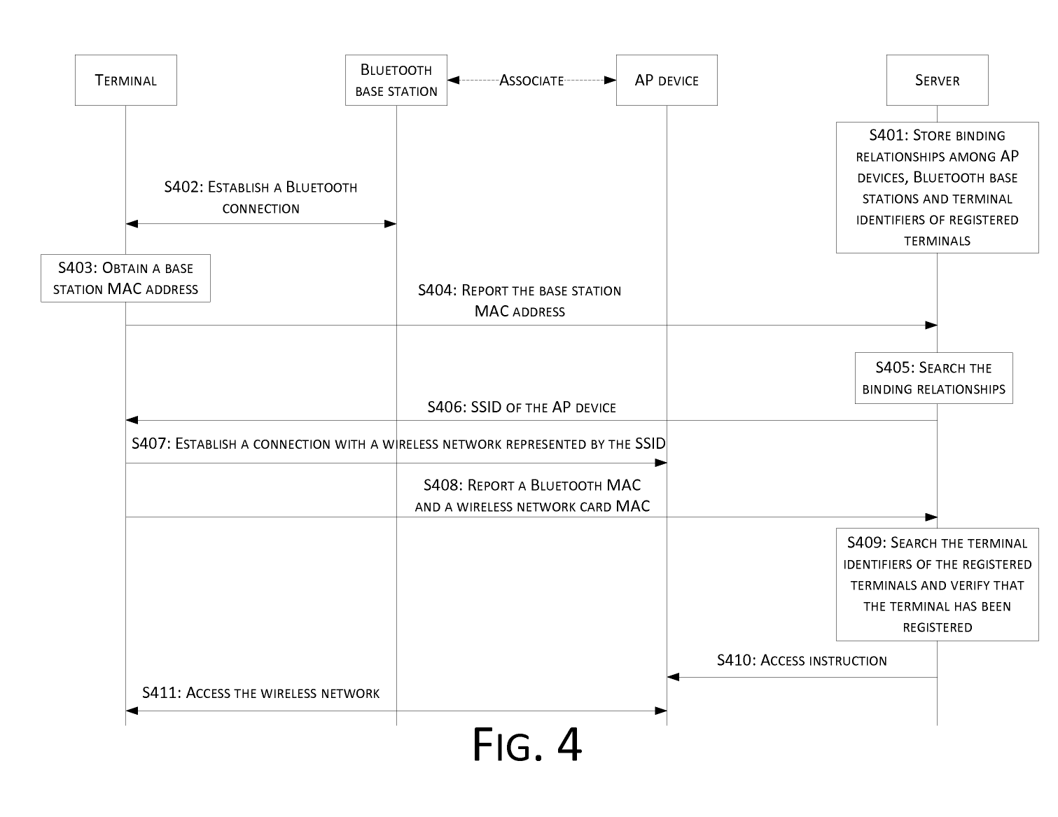

As shown in FIG. 4, FIG. 4 is a flowchart of another embodiment of the network access method in accordance with the present disclosure. This embodiment is described with reference to the application scenario that is shown in FIG. 3.

At block S401, a server stores binding relationships and terminal identifiers of terminals that have been registered.

In an embodiment, the server may pre-store binding relationships among device MAC addresses of AP devices, Service Set Identifier (SSID) of respective wireless networks provided by the AP devices, and base station MAC addresses of respective Bluetooth base stations that are associated with the AP devices. With reference to FIG. 3, the binding relationships may be represented by Table 1 as follows:

TABLE 1

| AP device | Device MAC | | |
|---|---|---|---|
| name | address | SSID | Base station MAC address |
| AP device | MAC100 | SSID100 | MAC1 (Bluetooth base station 1) |
| 100 | | | MAC2 (Bluetooth base station 2) |
| | | | MAC3 (Bluetooth base station 3) |
| | | | MAC4 (Bluetooth base station 4) |
| | | | MAC5 (Bluetooth base station 5) |

The server may further pre-store terminal identifiers of registered terminals. The terminal identifiers may include Bluetooth MAC addresses and wireless network card MAC addresses of the terminals. With reference to FIG. 3, after the terminal 200 registers with the server 300, a terminal identifier that is stored in the server 300 may be represented by Table 2 as follows:

TABLE 2

| | | Wireless network |
|---|---|---|
| Terminal name | Bluetooth MAC address | card MAC address |
| Terminal 200 | MAC2001 | MAC2002 |

At block S402, a terminal establishes a connection with a Bluetooth base station.

At block S403, the terminal obtains a base station MAC address of the Bluetooth base station.

At block S404, the terminal sends the base station MAC address to the server.

Referring to FIG. 3, at blocks S402-S404, the terminal 200 enters a signal region of the Bluetooth base station 3, establishes a Bluetooth connection with the Bluetooth base station 3, acquires a base station MAC address of Bluetooth base station 3 as MAC3, and sends MAC3 to the server 300.

At block S405, the server searches the binding relationships to obtain a device MAC address and a SSID of an AP device that corresponds to the base station MAC address.

The server searches Table 1 using MAC3 and obtains MAC100 and SSID100 that correspond to MAC3. In other words, the server 300 can know that an AP device that is associated with the Bluetooth base station 3 corresponding to MAC3 is the AP device 100.

At block S406, the server sends the SSID of the AP device to the terminal.

At block S407, the terminal establishes a connection with a wireless network represented by the SSID.

At blocks S406-S407, the server 300 sends SSID100 to the terminal 200, and the terminal 200 establishes a connection with a wireless network represented by SSID100. Generally, a SSID may be understood as a name of a wireless network provided by an AP device. A difference between the terminal establishing the connection with the wireless network represented by the SSID and the terminal finally accessing the wireless network is that, the former refers to establishing a network verification channel between the terminal and the wireless network, and the latter refers to an ability of accessing the Internet by the terminal through the wireless network after successful verification.

At block S408, the terminal reports a Bluetooth MAC address and a wireless network card MAC address of the terminal to the server.

At block S409, the server verifies that the terminal has been registered upon finding the Bluetooth MAC address and the wireless network card MAC address from among the terminal identifiers of the registered terminals.

With reference to FIG. 3, at blocks S408-S409, the terminal 200 sends MAC2001 of the Bluetooth module and MAC2002 of the wireless network card to the server 300. The server 300 may know that MAC2001 and MAC2002 that are bound are recorded in Table 2 by searching Table 2, and thus verifies that the terminal 200 has been registered.

At block S410, the server delivers an access instruction to the AP device.

At block S411, the AP device allows the terminal to access the wireless network according to the access instruction.

With reference to FIG. 3, at blocks S410-S411, the server 300 sends an access instruction that allows the terminal 200 to access the wireless network to the AP device 100. The access instruction may include the wireless network card MAC2002 of the terminal 200. The AP device 100 allows the terminal 200 to access the wireless network according to MAC200.

It should be noted that, in another optional implementation with reference to FIG. 4, the server may also deliver the binding relationships to the terminal which stores the binding relationships after block S401. After block S403, the terminal may directly search the binding relationships to obtain a SSID corresponding to the base station MAC address after obtaining the base station MAC address, and establish a connection with a wireless network represented by the SSID. Correspondingly, the server may not need to perform block S406. In other words, in the optional implementation, the responsibility of obtaining a SSID is transferred from the server side to the terminal side.

As can be seen from the foregoing method embodiment, when entering the coverage of a wireless network that is covered by an access point device and has Bluetooth base stations deployed therein, a terminal only needs to report a terminal identifier and a base station identifier of a Bluetooth base station that is found to a server. Upon verifying that the terminal is a registered terminal, the server delivers an instruction that allows the terminal to access the wireless network to an access point device associated with the Bluetooth base station so that the terminal can automatically access the wireless network without the need of a terminal user to perform cumbersome input operations manually, thereby improving the speed of accessing the network.

Corresponding to the embodiments of the methods of accessing a network in the present disclosure, embodiments of a network access apparatus, a server and a terminal are further provided in the present disclosure.

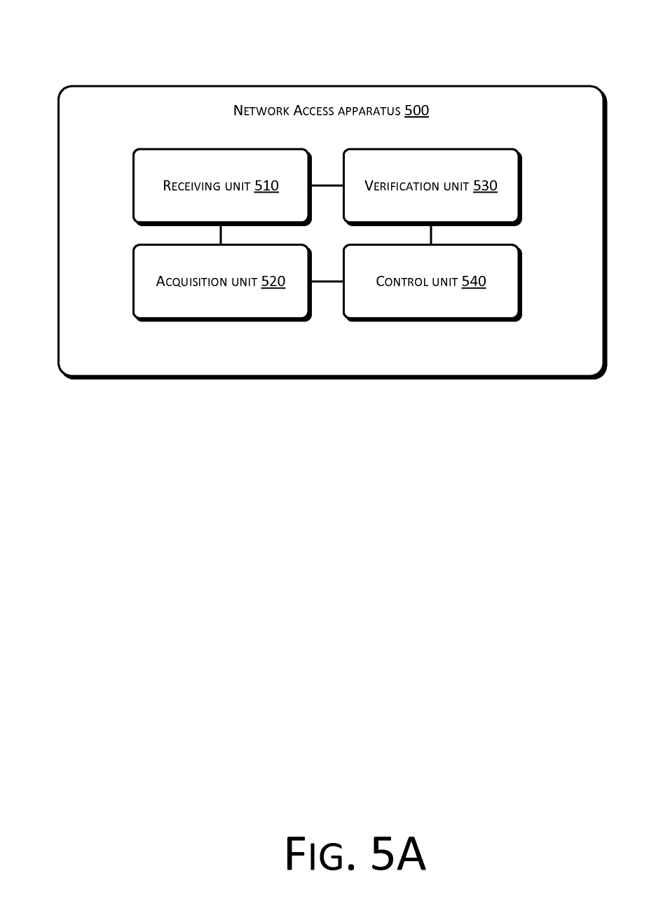

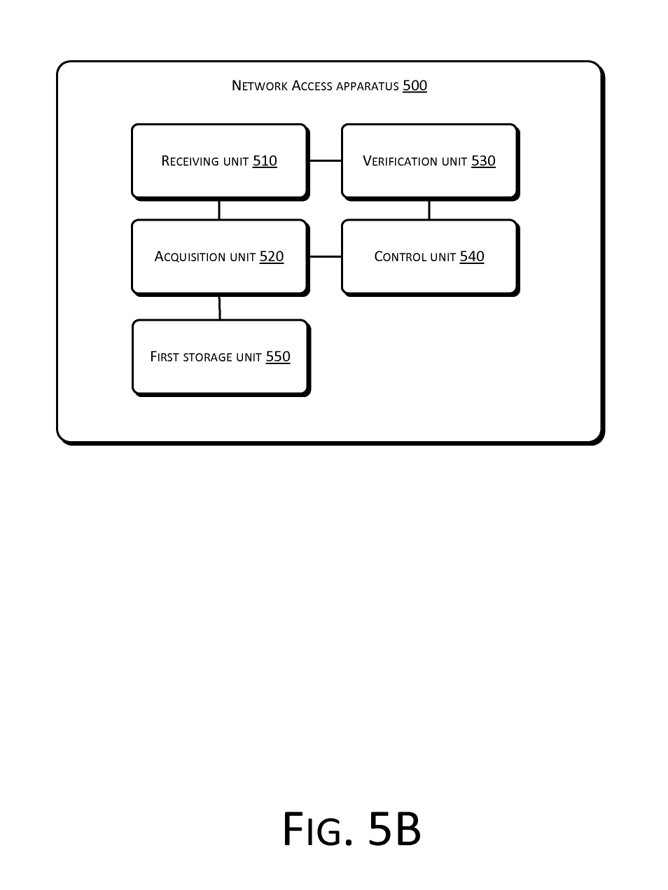

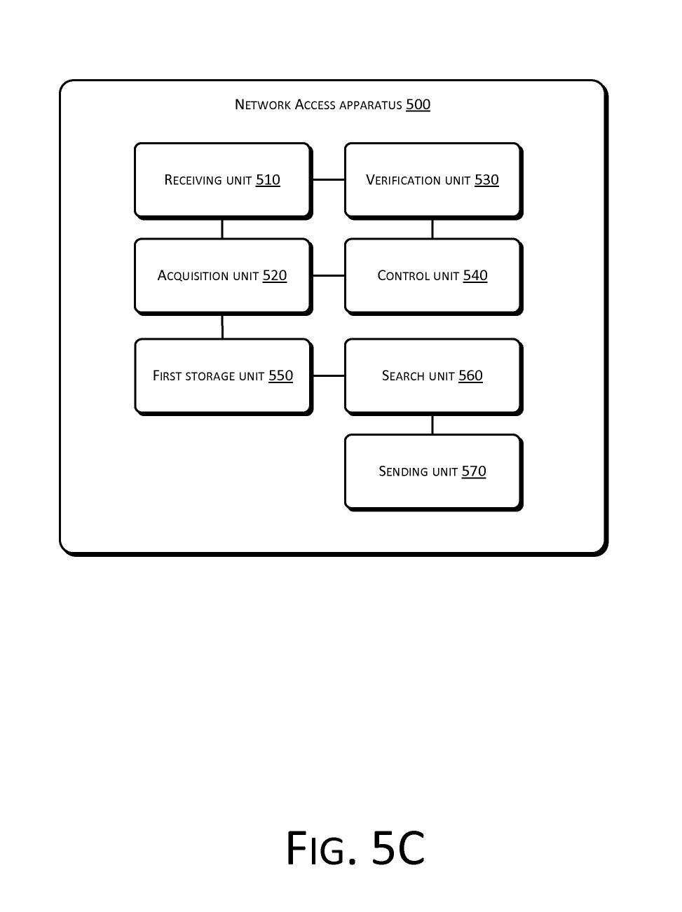

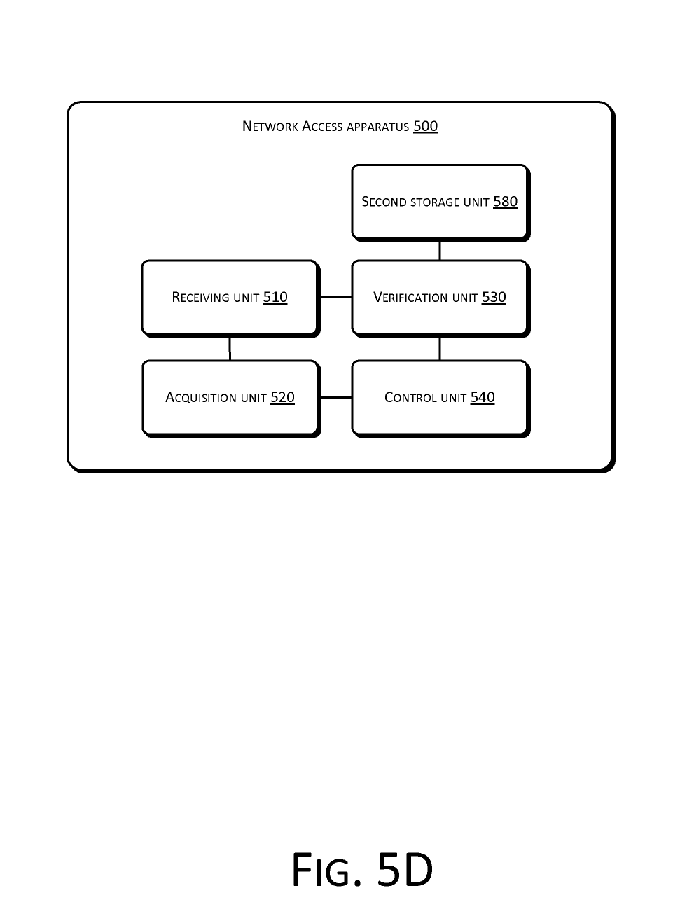

FIG. 5A shows a block diagram of an embodiment of a network access apparatus 500 in accordance with the present disclosure. The apparatus may be applied to a server. The apparatus includes: a receiving unit 510, an acquisition unit 520, a verification unit 530 and a control unit 540.

The receiving unit 510 is used for receiving a first base station identifier and a first terminal identifier of a terminal from the terminal, the first base station identifier being a base station identifier of a first Bluetooth base station that is acquired by the terminal after establishing a connection with the first Bluetooth base station.

The acquisition unit 520 is used for obtaining a first access point device associated with the first Bluetooth base station based on the first base station identifier received by the receiving unit.

The verification unit 530 is used for verifying whether the terminal has been registered based on the first terminal identifier received by the receiving unit.

The control unit 540 is used for delivering an access instruction to the first access point device after the verification unit verifies that the terminal has been registered to cause the first access point device to allow the terminal to access a wireless network.

FIG. 5B is a block diagram of another embodiment of the network access apparatus in accordance with the present disclosure. The apparatus 500 may be applied in a server. Based on the embodiment shown in FIG. 5A, the apparatus 500 may further include: a first storage unit 550.

The first storage unit 550 is used for pre-storing binding relationships between device identifiers of access point devices and base station identifiers of respective Bluetooth base stations that are associated with the access point devices.

The acquisition unit 520 may be used for searching the binding relationships stored by the first storage unit to obtain a first device identifier corresponding to the first base station identifier, and determining an access point device corresponding to the first device identifier as the first access point device.

FIG. 5C is a block diagram of another embodiment of the network access apparatus 500 in accordance with the present disclosure. The apparatus 500 may be applied in a server. Based on the embodiment shown in FIG. 5B, the apparatus 500 may further include: a search unit 560 and a sending unit 570.

The binding relationships stored by the first storage unit 550 may further include: service set identifiers (SSIDs) of the access point devices.

The search unit 560 is used for searching the binding relationships stored by the first storage unit to obtain a first SSID of the first access point device that corresponds to the first base station identifier.

The sending unit 570 is used for sending the first SSID obtained by the search unit to the terminal to enable the terminal to establish the connection with the wireless network represented by the first SSID.

FIG. 5D is a block diagram of another embodiment of the network access apparatus 500 in accordance with the present disclosure. The apparatus 500 may be applied in a server. Based on the embodiment shown in FIG. 5A, the apparatus 500 may further include: a second storage unit 580.

The second storage unit 580 is used for pre-storing terminal identifiers of registered terminals through which user registration is completed.

The verification unit 530 may be used for determining that the terminal has been registered in response to finding the first terminal identifier in the stored terminal identifiers of the registered terminals.

It should be noted that the second storage unit 580 in FIG. 5D may also be included in the embodiment in FIG. 5B or FIG. 5C, which is not limited by the present disclosure.

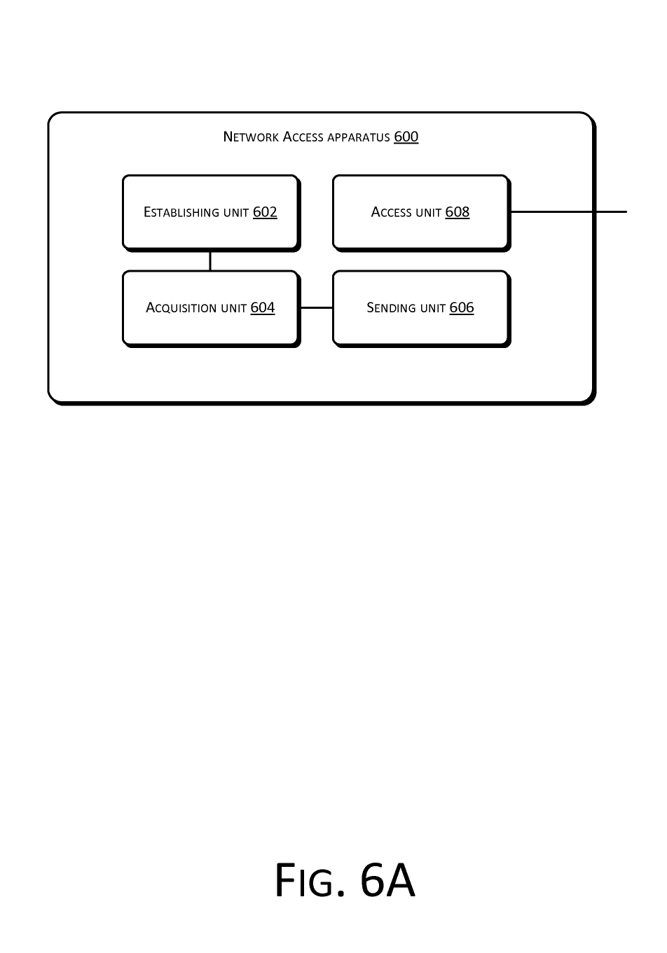

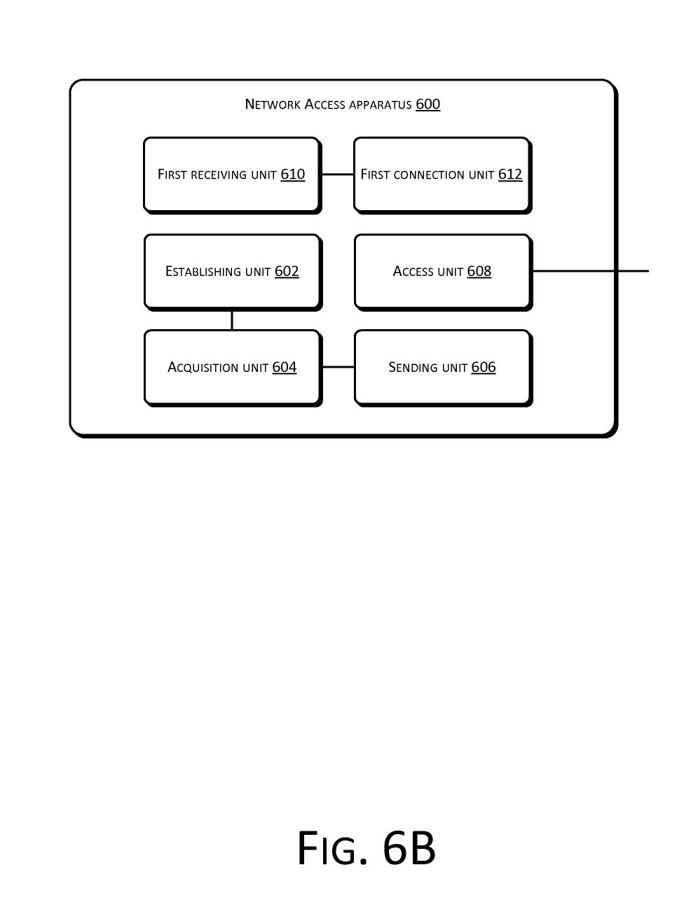

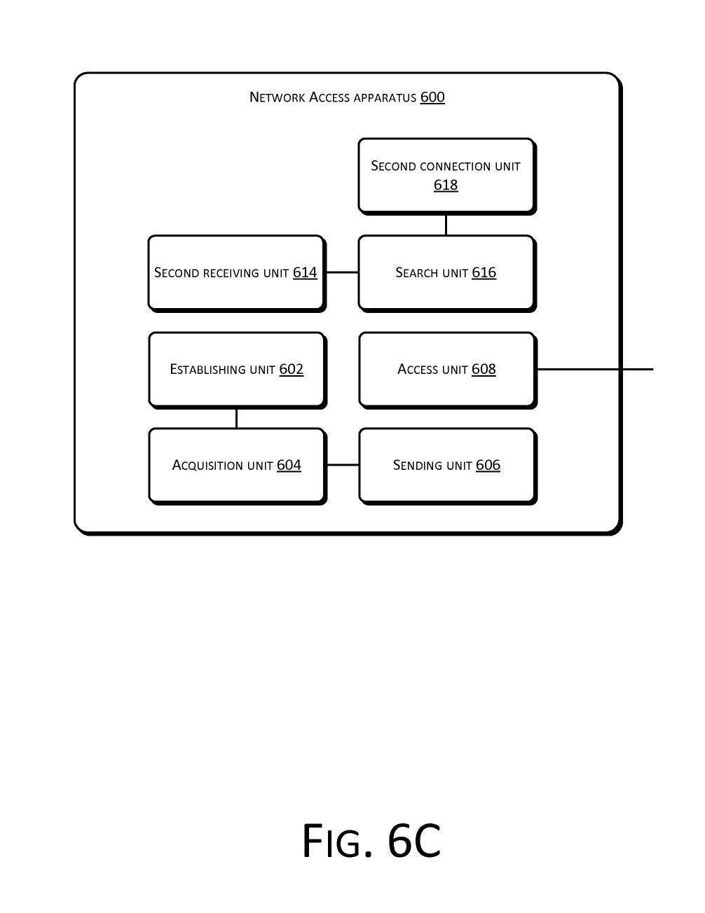

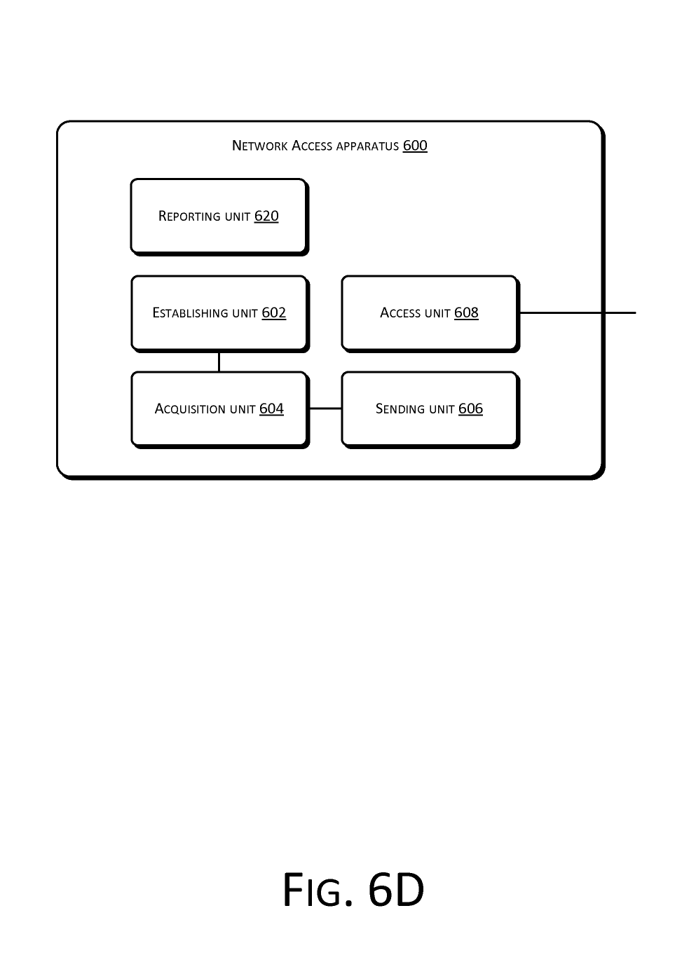

FIG. 6A is a block diagram of another embodiment of a network access apparatus 600 in accordance with the present disclosure. The embodiment may be applied in a terminal. The apparatus 600 includes: an establishing unit 602, an acquisition unit 604, a sending unit 606 and an access unit 608.

The establishing unit 602 is used for establishing a connection with a first Bluetooth base station.

The acquisition unit 604 is used for acquiring a first base station identifier of the first Bluetooth base station connected by the establishing unit 602.

The sending unit 606 is used for sending the first base station identifier and a first terminal identifier of the terminal to a server to cause the server to deliver an access instruction to a first access point device that is associated with the first Bluetooth base station and that is obtained based on the first base station identifier in response to verifying that the terminal has been registered based on the first terminal identifier to cause the first access point device to allow the terminal to access a wireless network.

The access unit 608 is used for accessing the wireless network provided by the first access point device.

FIG. 6B is a block diagram of another embodiment of the network access apparatus 600 in accordance with the present disclosure. The embodiment may be applied in a terminal. Based on the embodiment shown in FIG. 6A, the apparatus 600 may further include: a first receiving unit 610 and a first connection unit 612.

The first receiving unit 610 is used for receiving a first SSID of the first access point device from the server, the first SSID being a SSID that is obtained by the server after searching stored binding relationships and that corresponds to the first base station identifier sent from the sending unit 606, the binding relationships including binding relationships among device identifiers of access point devices, respective SSIDs of the access point devices, and base station identifiers of respective Bluetooth base stations that are associated with the access point devices.

The first connection unit 612 is used for establishing a connection with the wireless network represented by the first SSID that is received by the first receiving unit 610.

FIG. 6C is a block diagram of another embodiment of the network access apparatus 600 in accordance with the present disclosure. The embodiment may be applied in a terminal. Based on the embodiment shown in FIG. 6A, the apparatus 600 may further include: a second receiving unit 614, a search unit 616 and a second connection unit 618.

The second receiving unit 614 is used for receiving binding relationships from the server, the binding relationships including binding relationships among device identifiers of access point devices, respective SSIDs of the access point devices, and base station identifiers of respective Bluetooth base stations that are associated with the access point devices.

The search unit 616 is used for searching the binding relationships received by the second receiving unit 614 to obtain a first SSID corresponding to the first base station identifier.

The second connection unit 618 is used for establishing a connection with the wireless network represented by the first SSID that is found by the search unit 616.

FIG. 6D is a block diagram of another embodiment of the network access apparatus 600 in accordance with the present disclosure. The embodiment may be applied in a terminal. Based on the embodiment shown in FIG. 6A, the apparatus 600 may further include a reporting unit 620.

The reporting unit 620 is used for reporting the first terminal identifier of the terminal when a user registers with the server through the terminal, so that the server determines that the terminal has been registered upon finding the first terminal identifier that is sent from the terminal.

It should be noted that the reporting unit 600 shown in FIG. 6D may also be included in the embodiment shown in FIG. 6B or FIG. 6C above, which is not limited in the present disclosure.

Details of implementation processes of the functions and effects of each unit in the foregoing apparatuses can be found in implementation processes of corresponding blocks in the foregoing methods, and are not repeatedly described herein.

The apparatus embodiments substantially correspond to the method embodiments, and therefore reference may be made to the method embodiments for the relevant parts. The foregoing apparatus embodiments are merely exemplary. The units that are described as separate components may be or may not be physically separated, and components shown as units may be or may not be physical units, i.e., may be positioned in a single location or distributed among a plurality of network units. Some or all of the modules may be selected to achieve the objective of the solution of the present disclosure according to actual need. One of ordinary skill in the art can understand and implement the present disclosure without making any creative efforts.

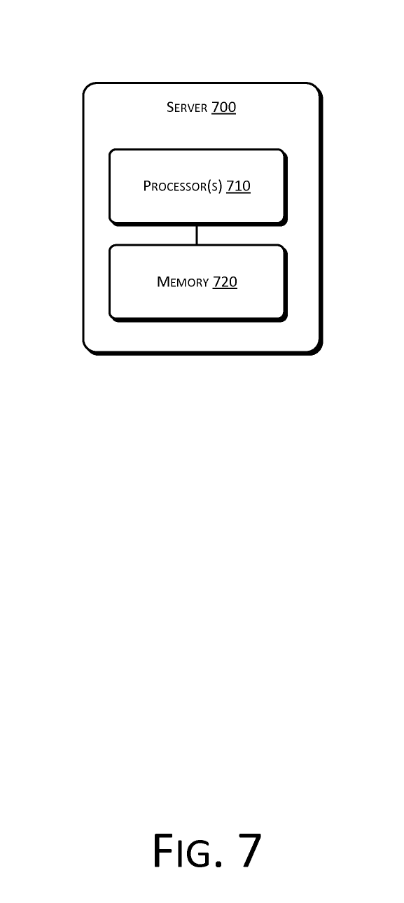

FIG. 7 is a block diagram of an embodiment of a server 700 in accordance with the present disclosure.

In an embodiment, the server 700 may include: processor(s) 710; and memory 720 storing instructions executable by the processor(s) 710. In addition, the server 700 may further include a network interface and other hardware devices that are not shown in FIG. 7.

The processor(s) 710 may be configured to: receive a first base station identifier and a first terminal identifier of a terminal from the terminal, the first base station identifier being a base station identifier of a first Bluetooth base station that is acquired by the terminal after establishing a connection with the first Bluetooth base station; obtain a first access point device associated with the first Bluetooth base station based on the first base station identifier; and deliver an access instruction to the first access point device to cause the first access point device to allow the terminal to access a wireless network in response to verifying that the terminal has been registered based on the first terminal identifier.

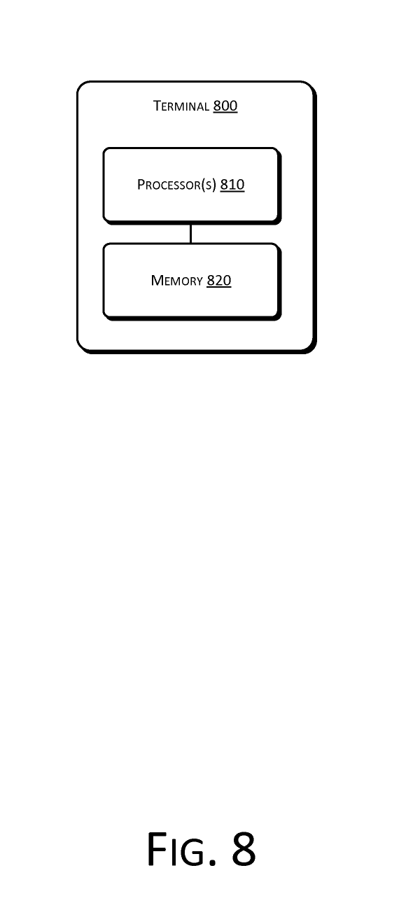

FIG. 8 is a block diagram of an embodiment of a terminal 800 in the present disclosure.

In an embodiment, the terminal 800 may include: processor(s) 810; and memory 820 storing instructions executable by the processor(s) 810. In addition, the terminal 800 may further include communication components, network interfaces, and other hardware devices that are not shown in FIG. 8.

The processor(s) 810 may be configured to: acquire a first base station identifier of a first Bluetooth base station after establishing a connection with the first Bluetooth base station; send the first base station identifier and a first terminal identifier of the terminal 800 to a server to cause the server to deliver an access instruction to a first access point device that is associated with the first Bluetooth base station and that is obtained based on the first base station identifier in response to verifying that the terminal 800 has been registered based on the first terminal identifier to cause the first access point device to allow the terminal 800 to access a wireless network; and access the wireless network provided by the first access point device.

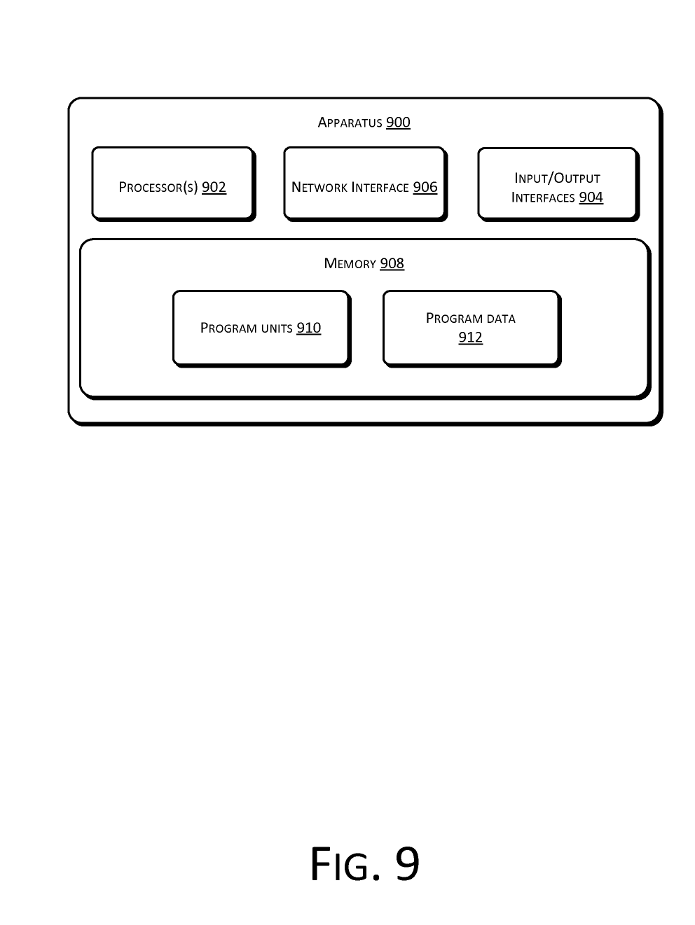

FIG. 9 shows a block diagram of an example apparatus 900, such as the apparatus 500, the apparatus 600, the server 700 and the terminal 800 described in FIGS. 5A-D, 6A-D, 7 and 8, in further detail. In an embodiment, the apparatus 900 may include one or more processors 902, an input/output interface 904, a network interface 906 and memory 908.

In an embodiment, the memory 908 may include a form of computer readable media such as volatile memory, Random Access Memory (RAM), and/or non-volatile memory, e.g., Read-Only Memory (ROM) or flash RAM, etc. The memory 608 is an example of a computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In an embodiment, the memory 908 may include program units 910 and program data 912. Depending on which apparatus (such as the apparatus 500 or the apparatus 600 in FIGS. 5A-D and 6A-D), server (such as the server 700) or terminal (such as the terminal 800) the apparatus 900 represents, the program units 910 may include one or more units in the embodiments of the apparatuses, servers and/or terminals described above. Details of these units can be found in the foregoing description of the embodiments, and are therefore not repeatedly described herein.

As can be seen from the foregoing embodiments, when entering the coverage of a wireless network that is covered by an access point device and has Bluetooth base stations deployed therein, a terminal only needs to report a terminal identifier and a base station identifier of a Bluetooth base station that is found to a server. Upon verifying that the terminal is a registered terminal, the server delivers an instruction that allows the terminal to access the wireless network to an access point device associated with the Bluetooth base station so that the terminal can automatically access the wireless network without the need of a terminal user to perform cumbersome input operations manually, thereby improving the speed of accessing the network.

Upon considering the specification and practicing the methods and apparatuses disclosed herein, one skilled in the art can easily conceive other implementation solutions of the present disclosure. The present disclosure is intended to cover any variations, uses or adaptations of the present disclosure. Such variations, uses or adaptations follow the general principles of the present disclosure and include common knowledge or customary technical means in this technical field, which are not disclosed in the present disclosure. The specification and embodiments are deemed as exemplary only, and the true scope and spirit of the present disclosure are indicated in the appended claims.

It should be understood that the present disclosure is not limited to the exact structure described above and shown in the accompanying drawings, and various types of modifications and changes can be made to the present disclosure without departing from the scope thereof the present disclosure. The scope of the present disclosure is defined by the appended claims.

What is claimed is:

1. A method implemented by one or more computing devices, the method comprising:
receiving a first base station identifier and a first terminal identifier of a terminal from the terminal, the first base station identifier being a base station identifier of a first base station that is acquired by the terminal after establishing a connection with the first base station;
obtaining a first access point device associated with the first base station based at least in part on the first base station identifier; and
sending an access instruction to the first access point device to cause the first access point device to allow the terminal to access a wireless network.

2. The method of claim 1, further comprising:
verifying that the terminal has been registered based at least in part on the first terminal identifier; and
sending the access instruction to the first access point device in response to verifying that the terminal has been registered.

3. The method of claim 1, further comprising storing binding relationships between device identifiers of access point devices and base station identifiers of respective base stations that are associated with the access point devices in advance.

4. The method of claim 3, wherein obtaining the first access point device comprises:
searching the binding relationships to obtain a first device identifier corresponding to the first base station identifier; and
determining an access point device corresponding to the first device identifier as the first access point device.

5. The method of claim 4, wherein:
the first base station identifier comprises a base station media access control (MAC) address of the first base station;
the first terminal identifier comprises one or more of: a MAC address and a wireless network card MAC address of the terminal; and
the first device identifier comprises a device MAC address of the first access point device.

6. The method of claim 3, wherein the binding relationships further comprise service set identifiers (SSIDs) of the access point devices.

7. The method of claim 6, further comprising:
searching the binding relationships to obtain a first SSID of the first access point device corresponding to the first base station identifier; and
sending the first SSID to the terminal to enable the terminal to establish a connection with the wireless network represented by the first SSID.

8. The method of claim 1, further comprising storing terminal identifiers of registered terminals through which user registration is completed in advance.

9. The method of claim 6, further comprising:
verifying that the terminal has been registered in response to finding the first terminal identifier in the stored terminal identifiers of the registered terminals; and
sending the access instruction to the first access point device in response to verifying that the terminal has been registered.

10. An apparatus comprising:
one or more processors;
memory;
an establishing unit stored in the memory and executable by the one or more processors to establish a connection with a first base station;
an acquisition unit to acquire a first base station identifier of the first base station that is connected by the establishing unit;
a sending unit to send the first base station identifier and a first terminal identifier of a terminal to a server to cause the server to deliver an access instruction to a first access point device that is associated with the first base station and that is obtained based at least in part the first base station identifier to enable the first access point device to allow the terminal to access a wireless network; and
an access unit to access the wireless network provided by the first access point device.

11. The apparatus of claim 10, further comprising:
a first receiving unit to receive a first service set identifier (SSID) of the first access point device from the server; and
a first connection unit to establish a connection with the wireless network represented by the first SSID received by the first receiving unit.

12. The apparatus of claim 10, wherein the first SSID is a SSID obtained after searching stored binding relationships and corresponds to the first base station identifier, the binding relationships comprising binding relationships among device identifiers of access point devices, respective SSIDs of the access point devices, and base station identifiers of respective base stations that are associated with the access point devices.

13. The apparatus of claim 10, further comprising:
a second receiving unit to receive binding relationships from the server, the binding relationships comprising binding relationships between device identifiers of access point devices, respective SSIDs of the access point devices, and base station identifiers of respective base stations that are associated with the access point devices;
a search unit to search the binding relationships received by the second receiving unit to obtain a first SSID corresponding to the first base station identifier; and
a second connection unit to establish a connection with the wireless network represented by the first SSID that is found by the search unit.

14. The apparatus of claim 10, further comprising a reporting unit to report the first terminal identifier of the terminal to the server when a user registers with the server through the terminal.

15. One or more computer-readable media storing executable instructions that, when executed by one or more processors, cause the one or more processors to perform acts comprising:
receiving a first base station identifier and a first terminal identifier of a terminal from the terminal, the first base station identifier being a base station identifier of a first base station that is acquired by the terminal after establishing a connection with the first base station;
obtaining a first access point device associated with the first base station based at least in part on the first base station identifier; and
sending an access instruction to the first access point device to cause the first access point device to allow the terminal to access a wireless network.

16. The one or more computer-readable media of claim 15, the acts further comprising:
verifying that the terminal has been registered based at least in part on the first terminal identifier; and
sending the access instruction to the first access point device in response to verifying that the terminal has been registered.

17. The one or more computer-readable media of claim 15, the acts further comprising storing binding relationships between device identifiers of access point devices and base station identifiers of respective base stations that are associated with the access point devices in advance.

18. The one or more computer-readable media of claim 17, wherein obtaining the first access point device comprises:
searching the binding relationships to obtain a first device identifier corresponding to the first base station identifier; and
determining an access point device corresponding to the first device identifier as the first access point device.

19. The one or more computer-readable media of claim 17, wherein the binding relationships further comprise service set identifiers (SSIDs) of the access point devices.

20. The one or more computer-readable media of claim 19, the acts further comprising:
searching the binding relationships to obtain a first SSID of the first access point device corresponding to the first base station identifier; and
sending the first SSID to the terminal to enable the terminal to establish a connection with the wireless network represented by the first SSID.
